(19) United States
(12) Patent Application Publication
(10) Pub. No.: US 2016/0230991 A1
(43) Pub. Date: Aug. 11, 2016

(54) ALTERNATE-SWITCHING REGENERATIVE COMBUSTION APPARATUS AND CONTROL METHOD THEREFOR

(71) Applicant: Hunan Baling Furnace Energy Conservation Co., Ltd., Hunan (CN)

(72) Inventor: Shaofang Zhou, Hunan (CN)

(21) Appl. No.: 15/023,743

(22) PCT Filed: Jul. 18, 2014
(86) PCT No.: PCT/CN2014/082554

§ 371 Date: Mar. 22, 2016

(30) Foreign Application Priority Data
Sep. 24, 2013 (CN) 201310437228.2

(51) Int. Cl. F23L 15/02; F23N 5/00; F27D 17/00

(52) U.S. Cl. CPC F23L 15/02; F27D 17/004; F23N 5/00

(57) ABSTRACT

Provided is an alternate-switching regenerative combustion apparatus, comprising at least three regenerative burners 2 communicating with a furnace hearth 101 which is provided in a furnace body 1, a controller for controlling the regenerative burners 2, a fuel gas pipeline 401, a combustion-supporting gas pipeline 402, a flue gas pipeline 403, and a reversing valve 5, wherein each of the regenerative burners 2 includes a burner nozzle 3 and a regenerative chamber 208. The burner nozzle 3 is in communication with the fuel gas pipeline 401. The regenerative chamber 208 has one end in communication with the furnace hearth 101 via the burner nozzle 3, and another end in communication with the combustion-supporting gas pipeline 402 and the flue gas pipeline 403 respectively via an air inlet 201 and a smoke vent 202. The controller switches the regenerative burners 2 to alternately use them for combustion and smoke evacuation, such that the number of the regenerative burners 2 for smoke evacuation is larger than the number of the regenerative burners 2 for combustion at any moments. Further provided is a method for controlling the alternate-switching regenerative combustion apparatus. The alternate-switching regenerative combustion apparatus has not only smooth smoke evacuation, a stable furnace pressure, and a relatively high overall recovery rate of residual heat from the flue gases, but also a homogeneous temperature distribution in the furnace, so that combustion of low nitrogen oxides at high temperature is achieved.

### CROSS-REFERENCE TO RELATED APPLICATIONS

The present application claims benefit of Chinese patent application CN 201310437228.2, entitled “Regenerative combustion system and method for controlling the same” and filed on Sep. 24, 2013, the entirety of which is incorporated herein by reference.

### FIELD OF THE INVENTION

The present invention relates to a thermal apparatus, and in particular, to an alternate-switching regenerative combustion apparatus and a method for controlling the alternate-switching regenerative combustion apparatus. The apparatus and method of the present invention are applicable to all industrial furnaces and boilers that require heat sources.

### BACKGROUND OF THE INVENTION

Industrial furnaces are main energy-consuming apparatuses in industrial production, accounting for 60% of a total industrial energy consumption. This renders researches into energy-saving technologies therein vitally significant.

Development of various industrial furnace energy-saving technologies at home and abroad has substantially gone through two stages, including disuse of residual heat of flue gases and use of residual heat of flue gases. In the early years, because residual heat in the furnaces was disused, the flue gases carried away huge amounts of heat, and the thermal efficiency of the furnaces was below 30%. During the 1960s and 1970s, an air pre-heater (or air heat exchanger), a device arranged in flue gas passages for recovering residual heat of flue gases, was commonly used in both China and abroad, for recovery of heat carried away by discharged flue gases. Such a device can be used to lower the temperature of discharged flue gases to a certain extent, and increase the temperature of combustion-supporting air entering the furnace hearth. A certain energy-saving effect was achieved. However, there existed various problems, such as relatively short service life, limited recovery rate of residual heat, generally 50% lower of thermal efficiency of the furnace, and still high temperature of discharged flue gases.

In the early 1980s, British Gas and Hot Work produced a regenerative burner, and developed “a first generation regenerative combustion technology” performed under high temperatures (see GB 2214625A). Thereafter, such burners were used in steel and melting aluminum industries in both the U.S. and the U.K. However, such burners had quite prominent problems including, among others, large emissions of NO and inferior system reliability.

During the 1990s, the problem of conflicts between energy saving and environment protection existing with a regenerative burner was elevated to a status among key scientific and technological projects in the academic circles in both China and abroad. And in-depth basic researches were done into such a project, with the purpose of simultaneous achievements of both saving energy and lowering emissions of CO₂ and NOₓ. NKK and NFK co-developed a new combustion technology, i.e., regenerative High Temperature Air Combustion (HTAC), which was referred to as “second generation regenerative combustion technology” (see JP 11/248081). Such a technology is now being widely used. The key point of HTAC lies in use of a regenerative combustion system, which can comprise a plurality of identical regenerative burners in paired arrangements. In each pair of the regenerative burners, one burner is used for combustion, and the other is used for smoke evacuation. Switching is performed after one cycle is completed, and a regenerator stores and releases heat alternately, as shown in FIG. 1.

For example, CN 101338904A, CN 101338906A, CN 101338907A, and CN 101338894A disclose various types of regenerative condensation energy saving furnaces, each of which comprises a plurality of regenerative burners in paired arrangements. Every two burners form a pair, and are periodically switched to each other to perform combustion. For each pair of burners, when one burner performs combustion, the other burner is closed. Although such a furnace can, to a certain degree, solve the problems of low temperature and inhomogeneous temperature distribution in a combustion chamber, burner backfire occurs rather easily while the furnace is being heated, due to instable and excessively high furnace pressures. This would affect normal use, and safe performance thereof is therefore inferior.

On the one hand, among existing regenerative combustion systems with burners in paired arrangements, a pipeline space used by combustion-supporting gas which supports combustion is equal to a flue gas pipeline space used in smoke evacuation, while the combustion-supporting gas, after being mixed with a fuel, will generate flue gases which have a larger volume. In fact, the volume of the flue gases under standard conditions is at least 1.1-1.3 times the volume of the combustion-supporting gas. When the temperature for smoke evacuation is 180° C., the working condition volume of the flue gases will be 1.6-1.8 times that of the combustion-supporting gas, thus causing the furnace hearth to be in high-pressure, unsafe conditions. Currently, the following solutions are employed.

(1) The pressure of an induced draft fan is increased to decrease the furnace pressure. Since hot pressure of the induced draft fan decreases, a theoretical balance of furnace pressure cannot be formed unless a cold pressure of the induced draft fan is increased to 3-5 times the pressure of a combustion-supporting blower. Although this can, to a certain extent, solve the problem of too high a furnace pressure, the configuration and operation costs are excessively high.

(2) An opening area of a burner nozzle or a flow passage area of the regenerator is increased to lower the furnace pressure. However, this would lead to other problems, such as inferior mixing effects between the combustion-supporting gas and the fuel. As a result, there would be an excessive amount of combustion-supporting gas left and combustion efficiency would be reduced, thus severely affecting shape and stiffness of flames and increasing emissions of NO and CO₂.

(3) A subsidiary conduit (a pressure relief opening) is directly arranged on the furnace body, thereby discharging 30-40% of the high-temperature flue gases through the subsidiary conduit and lowering the furnace pressure. For example, such a procedure is used in the technical solution disclosed by WO 01/16527A1. However, this would cause a recovery rate of residual heat of the flue gases to be only 50-60%, which indicates unsatisfactory effects in energy conservation and environment protection. In addition, an excessively high temperature for smoke evacuation would impose negative influences on safe operation of the apparatus.

As can be seen, unsmooth smoke evacuation, excessively high furnace pressure, and low recovery rate of an overall residual heat of flue gases are now the technical problems still to be solved in the HTAC technology.

On the other hand, the existing regenerative combustion system with burners in paired arrangements has relatively large fluctuations in furnace pressures during switch, which would largely impact the furnace hearth in serious conditions, and affect safe operation of the apparatus.

In addition, an under-mounted regenerator is at present commonly used in the HTAC technology, under which circumstances, the regenerative burner discharges smoke downwards, and dusts accumulate at an upper portion of the regenerator easily. Moreover, the speed of air is smaller than that of the smoke in the regenerator, and the regenerator is inadequately capable of self-cleaning, rendering the regenerator easily dusty and hardened. This would severely shorten cleaning cycles and service life of the regenerator, and currently becomes another technical problem to be solved in the HTAC technology.

In this regard, the inventor of the present invention has conducted in-depth researches, for the purpose of solving at least some of the problems exposed in existing technologies of relevant art, and hopefully, providing an environmental friendly, energy saving, and safe regenerative combustion apparatus and a method for controlling the apparatus.

### SUMMARY OF THE INVENTION

Through numerous experiments and creative work, the inventor of the present invention has discovered that, at least three regenerative burners arranged on a regenerative combustion apparatus, more regenerative burners for smoke evacuation than regenerative burners for combustion at any moments, prompt evacuation of flue gases from the furnace hearth by the regenerative burners for smoke evacuation, and in particular, simultaneous, successive, and periodical alternate-switching of the regenerative burners by a controller not only can significantly improve a recovery rate of residual heat of flue gases, reduce emissions of NOₓ, and achieve double benefits of energy saving and environment protection, but also can realize smooth smoke evacuation of the regenerative combustion apparatus, enormously improve stability of operation of the apparatus, and guarantee safe operation of the apparatus. In addition, the apparatus is of superior self-cleaning function, thus substantially prolonging cleaning cycles and service life of the apparatus, and alleviating workload and costs for maintenance of the regenerator. The present invention is completed on the above basis.

Therefore, one purpose of the present invention is to provide an alternate-switching regenerative combustion apparatus, comprising at least three regenerative burners and a controller for controlling the regenerative burners. The controller switches the regenerative burners to combustion and smoke evacuation alternately, and enables the number of regenerative burners for smoke evacuation is larger than the number of regenerative burners for combustion at any moments. The present invention has overcome the technical prejudice of paired arrangements of regenerative burners in conventional regenerative combustion technologies, and effectively solved a series of technical problems such as unsmooth smoke evacuation, excessively high furnace pressure, and low recovery rate of residual heat of flue gases.

Another purpose of the present invention is to provide a method for controlling the regenerative combustion apparatus. With the method for controlling the regenerative combustion apparatus of the present invention, it can be ensured that the number of regenerative burners for smoke evacuation is always larger than the number of regenerative burners for combustion, thus ensuring smooth evacuation and safe production of the apparatus, and improving reliability and safety of the regenerative combustion apparatus in combustion production. In addition, all flue gases generated during combustion are discharged by the regenerative burners in a prompt manner. A recovery rate of the residual heat of flue gases can reach higher than 80%, thereby saving at least 20-25% of energy as compared with a control method for an existing regenerative combustion system. This indicates tremendous energy-saving potential.

### BRIEF DESCRIPTION OF THE DRAWINGS

In order to explicitly illustrate the technical solution of the embodiments of the present invention, the embodiments will be described in combination with accompanying drawings. Obviously, the accompanying drawings as briefly described below represent merely some embodiments of the present invention. Starting from these drawings, those skilled in the art can acquire other accompanying drawings without any creative work. In the drawings:

FIG. 1 schematically shows a regenerative combustion system having burners in paired arrangements in the prior art;

FIG. 2 schematically shows the structure of an apparatus connected to three regenerative burners according to one preferred embodiment of the present invention;

FIG. 3 schematically shows the structure of the apparatus connected to five regenerative burners according to one preferred embodiment of the present invention;

FIG. 4 schematically shows the structure of a regenerative burner according to one preferred embodiment of the present invention; and

FIG. 5 schematically shows a flow chart of a method for controlling the regenerative combustion apparatus according to one preferred embodiment of the present invention.

In the accompanying drawings, the same components are indicated by the same reference signs. The accompanying drawings are not drawn to an actual scale.

### DETAILED DESCRIPTION OF THE EMBODIMENTS

According to one aspect of the present invention, an alternate-switching regenerative combustion apparatus is provided, comprising at least three regenerative burners communicating with a furnace hearth, and a controller used for controlling the regenerative burners, wherein the controller switches the regenerative burners to combustion and smoke evacuation alternately, so as to enable, at any moments, the regenerative burners used for smoke evacuation to be more than the regenerative burners used for combustion.

The apparatus of the present invention is provided with a plurality of regenerative burners. And the controller can ensure that, at any moments, the number of regenerative burners used for smoke evacuation is larger than the number of regenerative burners used for combustion. As a result, the apparatus can discharge high-temperature flue gases generated during combustions in time, so as to guarantee smooth smoke evacuation and safe production of the apparatus.

According to one specific embodiment of the present invention, the apparatus of the present invention is hermetically sealed, and flue gases in the furnace hearth are thus all discharged through the regenerative burners for smoke evacuation.

According to the apparatus of the present invention, no subsidiary conduits or pressure relief openings are arranged on a furnace body. As a result, the high-temperature flue gases generated during combustion will be all discharged through the regenerative burners used for smoke evacuation. Thus, the temperature of smoke evacuation in the regenerative chamber will precisely be the actual temperature of smoke evacuation. This enables an overall heat recovery rate of residual heat of flue gases to reach higher than 80%, thereby saving at least 20-25% of energy as compared with a regenerative combustion system having burners in paired arrangements in the prior art. Hence, the apparatus of the present invention not only solves the problem of a relatively low recovery rate of residual heat of flue gases in the prior art, but also is more energy saving compared with the prior art.

According to the apparatus of the present invention, it is unnecessary to increase an opening area of a nozzle of the regenerative burners or an air flow passage area of a regenerator in a regenerative chamber, thereby solving the problems such as an excessive amount of combustion-supporting gases left, relatively low combustion efficiency, inferior shape and stiffness of flames in the regenerative combustion system of the prior art, and significantly decreasing the amount of pollutants generated in the flue gases such as CO, CO₂, and NO_{X}.

According to one specific embodiment of the present invention, the controller switches at least one of the regenerative burners for combustion to smoke evacuation, and meanwhile switches at least one of the regenerative burners for smoke evacuation to combustion. Such simultaneous switching can be performed to achieve ultimate recovery of residual heat of flue gases and efficient preheating of combustion-supporting gases.

According to one specific embodiment of the present invention, the controller switches one of the regenerative burners for combustion to smoke evacuation, and meanwhile switches one of the regenerative burners for smoke evacuation to combustion. This will lead to better smoke evacuation effects, higher recovery rates of residual heat of flue gases, and stabler furnace pressures.

According to one specific embodiment of the present invention, the controller switches the regenerative burners for combustion to smoke evacuation successively, and switches the regenerative burners for smoke evacuation to combustion successively. Thus, the time for smoke evacuation of a single regenerative burner can be prolonged, thereby rendering thermal absorption of the regenerator more adequate. As a result, an overall residual heat of high-temperature flue gases can be recovered to a maximum extent under the conditions of safe production, thus improving manufacture and surrounding environments, significantly lowering losses of residual heat, and reducing labor intensity in production. Through numerous experiments, the inventor of the present invention has proved that, according to the apparatus of the present invention, the high-temperature flue gases can be discharged at a temperature not higher than 200° C., not higher than 180° C., not higher than 150° C., or not higher than 130° C. via a reversing valve. When the regenerative burner for smoke evacuation is switched to combustion, the temperature efficiency for preheating of the combustion-supporting gases can be improved to higher than 90%, and the temperature of the combustion-supporting gases can be about only 100° C. lower than that of the furnace hearth, thereby apparently reducing variation of differential pressures in the furnace hearth and ensuring stable operation of combustion production.

According to one specific embodiment of the present invention, the controller switches the regenerative burners for combustion periodically to smoke evacuation, and switches the regenerative burners for smoke evacuation periodically to combustion. This can eliminate local high-temperature regions in the furnace hearth, and enable more homogeneous temperature distribution.

According to one specific embodiment of the present invention, the combustion time of the regenerative burner for combustion is in the range from 15 to 300 s, preferably 30 to 200 s each time. The controller switches the regenerative burners to combustion and smoke evacuation alternately. When the regenerative burners are for combustion, they can preheat the combustion-supporting gases; while when the regenerative burners are for smoke evacuation, they can absorb heat of high-temperature flue gases generated during combustion. Through accurate control over the time for combustion of the regenerative burners, not only the recovery rate of residual heat of the flue gases can be increased, but combustion efficiency can also be improved.

According to one specific embodiment of the present invention, the regenerative burner comprises at least one burner nozzle communicating with the furnace hearth. And the burner nozzles of the regenerative burners simultaneously switched at each time have a same total power as the burner nozzles of the regenerative burners simultaneously switched at any other time. The burner nozzles communicate with a fuel gas pipeline through which fuel gases are supplied.

According to one specific embodiment of the present invention, each of the regenerative burners comprises a regenerative chamber, which has one end communicating with the furnace hearth via the burner nozzle, and another end provided with an air inlet and a smoke event. The air inlet communicates with a combustion-supporting gas pipeline through which combustion-supporting gases are supplied, and the smoke vent communicates with a flue gas pipeline for smoke evacuation. The fuel gas pipeline, the combustion-supporting gas pipeline, and the flue gas pipeline are all provided with respective reversing valves, which are all connected to the controller. The combustion-supporting gas pipeline and the flue gas pipeline are respectively are respectively connected to an air blower and an induced draft fan. The combustion-supporting gas pipeline, the flue gas pipeline, and the fuel gas pipeline can be further connected to devices such as a flowmeter, a pressure gauge, a differential pressure transmitter, a temperature sensor, or the like.

According to one specific embodiment of the present invention, the regenerative chamber is provided with a regenerator therein, which is in the shape of a sheet, strip, honeycomb, or sphere, preferably a sphere. The regenerator is made of clay, mullite, high aluminum, corundum, or silicon carbide, preferably corundum.

According to the apparatus of the present invention, when the regenerator is in the shape of a sphere, smoke resistance will be relatively small, and the regenerator will have increased bulk density and thermal storage capacity, thereby satisfying the requirements for long-term smoke evacuation of a single regenerative chamber.

In the apparatus of the present invention, when the regenerator is made of corundum, it will have the following features: long-term use due to its erosion resistance, large heat storage capacity due to its high density, fast accumulation and release of heat due to its high thermal conductivity coefficient, small amounts of viscous slag formation due to its penetration resistance, and being washable and reusable due to its high strength.

According to one specific embodiment of the present invention, the regenerator is located above the burner nozzle. Therefore, when the regenerative burner is used for smoke evacuation, the smoke will pass through the regenerator from bottom to top, and it is difficult for dusts to accumulate on the regenerator. When the regenerative burner is used for combustion, combustion-supporting gases pass through the regenerator from top to bottom. Compared with a conventional regenerative combustion apparatus provided with paired burners, the apparatus according to the present invention has significantly improved self-cleaning capability because the speed at which the combustion-supporting gases pass through the regenerator is higher than that at which the flue gases pass through the regenerator. As a result, the regenerator does not easily get dusty or hardened, thereby remarkably extending cleaning cycles and service life of the regenerator.

According to one specific embodiment of the present invention, the regenerative chambers are all located on a furnace roof.

In the apparatus of the present invention, the regenerative chambers are all located on a top portion of the furnace body. One the one hand, this will enable the regenerative chambers not to severely interfere with the arrangements such as a furnace base, an operating platform, a material inlet or outlet, a magnetic stirrer, and an exhaust pipe, thereby benefiting mounting of the apparatus. On the other hand, the smoke evacuation efficiency of the apparatus can be effectively improved.

According to one specific embodiment of the present invention, the regenerative chamber is divided, by grate brick having a through-hole, into two portions including an upper portion and a lower portion, wherein the regenerator is located above the grate brick, and a dust chamber is provided below the grate brick.

According to one specific embodiment of the present invention, above the grate brick, it is provided with a high-temperature section adjacent to the grate brick and a low-temperature section adjacent to the smoke vent.

According to one specific embodiment of the present invention, the regenerator includes a plurality of large-diameter regenerative spheres located in the high-temperature section, and a plurality of small-diameter regenerative spheres located in the low-temperature section.

When the apparatus of the present invention is used to perform combustion production, high-temperature flue gasses in the furnace hearth, after entering the regenerative chamber, will pass through the regenerator via the through-hole of the grate brick and enter the high-temperature section rapidly. Since large-diameter regenerative spheres are disposed in the high-temperature section with relatively large intervals therebetween, the flue gases have rather large flow areas. While passing through the large-diameter regenerative spheres, the flue gases transfer heat to these large-diameter regenerative spheres, such that the flue gases, after passing through the high-temperature section, will, with reduced temperatures, carry along reduced amounts of heat. The flue gases of relatively low temperatures will subsequently enter the low-temperature section, wherein a large number of small-diameter regenerative spheres having large specific surface areas are located. As such, the flue gases of relatively low temperatures will be in adequate contact with the small-diameter regenerative spheres, which can facilitate heat exchange therebetween. This can reduce pressure losses of the flue gases in the high-temperature section, and meanwhile ensure adequate thermal storage in the low-temperature section, thereby bringing down operating costs of production. After adequate heat absorption of the high-temperature flue gases by the regenerator, the flue gases can be finally discharged from the smoke vent by the induced draft fan at a temperature lower than 150° C.

According to one specific embodiment of the present invention, the regenerative burners are the same with one another, thereby facilitating better combustion and smoke evacuation effects.

According to one specific embodiment of the present invention, a plurality of regenerative burners can constitute one burner unit. The apparatus can comprise a plurality of burner units. The controller switches the plurality of burner units to combustion and smoke evacuation, alternately, so as to enable the apparatus to have more regenerative burner units for smoke evacuation than the regenerative burner units for combustion at any moments. High-temperature flue gases in the furnace hearth are all discharged via the burner units for smoke evacuation.

In the apparatus of the present invention, the furnace body comprises a furnace hearth, a furnace wall, a furnace floor, a furnace roof, and a furnace door provided in the furnace wall, wherein the furnace hearth, enclosed by the furnace wall, the furnace roof, and the furnace floor, is a three-dimensional space for combustion. The furnace wall, the furnace floor, and the furnace roof are all together named a furnace lining. During operation of the furnace, the furnace lining not only can maintain sufficient strength and stability under the conditions of high temperature and load, but also can sustain gas flushing and slag corrosion in the furnace hearth. In addition, the furnace lining has the performances of sufficient heat insulation and air tightness.

In the apparatus of the present invention, the furnace hearth is provided with sufficient space and heating surface, and reasonable shapes and sizes. Thus, the furnace hearth can be conveniently engaged with the burners, to organize an aerodynamic field in the furnace, thus enabling the flames not to adhere or rush to the wall. As a result, high fullness of the flames and homogeneous thermal load of a wall surface will be obtained.

In the apparatus of the present invention, the controller, as per a predetermined composition program, selects and switches, within a short time period, the regenerative burners to combustion and smoke evacuation, alternately. A controller for execution of order control or computer control comprises a programmable controller of at least one central processing unit, a ROM storage program, an interface, etc. In the apparatus of the present invention, the controller is respectively connected to an ignition device, and a plurality of control valves including a fuel gas valve, a combustion-supporting gas reversing valve, a flue gas reversing valve, and the like, for controlling ignition work of the ignition device and reversing work of the control valves.

In the apparatus of the present invention, the combustion-supporting gas can be air, enriched oxygen, or oxygen.

In the apparatus of the present invention, a fuel can be a gas fuel or a liquid fuel. Examples of gas fuels that can be used in the present invention include but are not limited to natural gas, blast furnace gas, coke oven gas, converter gas, producer gas, and mixed gases.

In the apparatus of the present invention, the grate brick can be a metal material or non-metal material. Examples of materials that can be used for the grate brick of the present invention include but are not limited to heat resisting cast iron, heat resisting steel, unshaped refractories, and shaped refractories.

In the apparatus of the present invention, the burner nozzle refers to a device which, as per a certain proportion and specific mixing conditions, supplies the fuel and the combustion-supporting gas into the furnace for combustion or achieves combustion within the burner nozzle per se.

According to another aspect of the present invention, a method for controlling a regenerative combustion apparatus is provided, comprising:

starting, in a starting sep, m regenerative burners for combustion, and meanwhile starting n regenerative burners for smoke evacuation, wherein n and m are both natural numbers, and n>m, and n+m≧3;

enabling, in a combustion step, the regenerative burners for combustion to perform combustion, and the regenerative burners for smoke evacuation to discharge flue gases from a furnace hearth;

switching, in a switching step, at least one of the regenerative burners for combustion to smoke evacuation, and meanwhile switching at least one of the regenerative burners for smoke evacuation to combustion, so as to enable the regenerative burners for smoke evacuation to be more than the regenerative burners for combustion; and

returning to, a circulation step, the combustion step and the switching step until combustion finishes.

The method for controlling a regenerative combustion apparatus of the present invention can ensure that the number of burners in smoke evacuation is always larger than that of burners in combustion, thus ensuring smooth smoke evacuation and safe production in the apparatus, and improving stability and safety of the regenerative combustion apparatus in combustion production. Moreover, according to the method of the present invention, high-temperature flue gases generated during combustion can be promptly discharged via the regenerative burners. An overall recovery rate of residual heat of flue gases can be improved to higher than 80%, thereby saving at least 20-25% of energy as compared with the method for controlling a regenerative combustion system in the prior art. This is rather enormous potential for saving energy, thereby not only solving the problem of a relatively low recovery rate of residual heat if flue gases, but also being more energy efficient and environment friendly as compared with the prior art.

According to one specific embodiment of the present invention, flue gases in the furnace hearth are all discharged via the regenerative burners for smoke evacuation.

According to the method of the present invention, the high-temperature flue gases generated during combustion are all discharged via the regenerative burners for smoke evacuation, and the temperature for smoke evacuation in the regenerative chamber is exactly the actual temperature for smoke evacuation, which is more energy efficient as compared with the prior art. In addition, the method of the present invention solves the problems such as excessive amount of combustion-supporting gases left in the regenerative combustion system, relatively low combustion efficiency, and inferior flame shape and stiffness in the prior art. Through the method of the present invention, the amounts of pollutants such as CO, CO₂, and NOₓ generated in the flue gases can be significantly decreased.

According to one specific embodiment of the present invention, in the switching step, at least one of the regenerative burners for combustion is switched to smoke evacuation, and meanwhile at least one of the regenerative burners for smoke evacuation is switched to combustion. Such simultaneous switching can realize ultimate recovery of residual heat of the flue gases and efficient preheating of the combustion-supporting gases.

According to one specific embodiment of the present invention, in the switching step, one of the regenerative burners for combustion is switched to smoke evacuation, and meanwhile one of the regenerative burners for smoke evacuation is switched to combustion, thereby achieving better smoke evacuation effects and stable furnace pressure.

According to one specific embodiment of the present invention, in the switching step, regenerative burners for combustion are successively switched to smoke evacuation, and regenerative burners for smoke evacuation are successively switched to combustion. This is to guarantee that the number of the regenerative burners for smoke evacuation is larger than that of the regenerative burners for combustion. As a result, the operating time of a single regenerative burner for smoke evacuation will be prolonged. This will enable the regenerator to absorb heat more adequately, thereby facilitating maximum recovery of residual heat of the high-temperature flue gases, improving production and surrounding environment, significantly relieving thermal losses of the flue gases, and reducing labor intensity in production. Moreover, through the method of the present invention, variation in differential pressure in the furnace hearth can be further dropped, thereby ensuring stable operation of combustion production.

According to one specific embodiment of the present invention, in the switching step, regenerative burners for combustion are periodically switched to smoke evacuation, and regenerative burners for smoke evacuation are periodically switched to combustion. This can eliminate local high temperature regions in the furnace hearth, and enables the temperature distribution to be more homogeneous.

According to one specific embodiment of the present invention, during one cycle, the combustion time of each of the regenerative burners for combustion is T×m/(m+n), wherein T represents duration of one cycle.

According to one specific embodiment of the present invention, in the starting step, the m regenerative burners are simultaneously started for combustion, wherein m≧2.

In the following, the embodiments of the present invention will be explained in detail in connection with accompanying drawings. However, those skilled in the art will understand that, the following embodiments are used for explanation of the present invention only, rather than as limitations to the scope of the present invention.

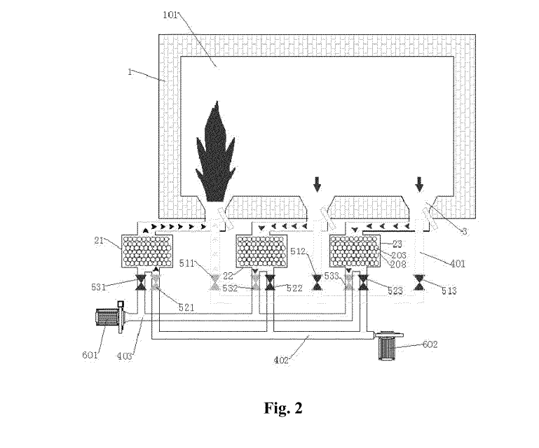

FIG. 2 shows a preferred embodiment of the present invention. In the embodiment as shown in FIG. 2, an alternate-switching regenerative combustion apparatus comprises a furnace body 1, a furnace hearth 101 provided in the furnace body 1, three regenerative burners 2, a fuel gas pipeline 401, a combustion-supporting gas pipeline 402, a flue gas pipeline 403, and a reversing valve 5.

The furnace body 1 is free from with any subsidiary conduits that communicate with the furnace hearth 101 and are used for directly discharging flue gases out of the furnace hearth. Therefore, the furnace body is of strict air tightness.

The furnace hearth 101 is provided with a plurality of openings on a hearth wall thereof. A first regenerative burner 21, a second regenerative burner 22, and a third regenerative burner 23 are all arranged at the openings of the furnace hearth 101, and communicate with the furnace 101 via the openings, so as to be connected to the furnace body 1.

Each of the regenerative burners comprises a burner nozzle 3 and a regenerative chamber 208. The burner nozzle 3 communicates with the fuel gas pipeline 401, through which fuel gas is supplied. The regenerative chamber 208 has one end communicating with the furnace hearth 101 via the burner nozzle 3, and another end communicating, via an air inlet 201 and a smoke vent 202, with the combustion-supporting gas pipeline 402 used for supplying combustion-supporting gases, and the flue gas pipeline 403 used for smoke evacuation, respectively.

The regenerative chamber 208 is filled with a regenerator 203. The combustion-supporting gas pipeline 402 communicates with the regenerator 203 via a combustion-supporting gas reversing valve 52; the flue gas pipeline 403 communicates with the regenerator 203 via a flue gas reversing valve 53; and combustion-supporting gas pipeline 402 has one end communicating with the burner nozzle 3 via a fuel gas valve 51, and another end communicating with a fuel gas source. The burner nozzle 3 is provided with an ignition device thereon.

The fuel gas valve 51, the combustion-supporting gas reversing valve 52, the flue gas reversing valve 53, and the ignition device are all connected to a controller. At each switching, the controller, through controlling the fuel gas valve 51, the combustion-supporting gas reversing valve 52, the flue gas reversing valve 53, and the ignition device, achieves the purpose of alternate operations of combustion and smoke evacuation of the regenerative burner 2. That is, the controller can control the activation and deactivation of the fuel gas pipeline 401, the combustion-supporting gas pipeline 402, and the flue gas pipeline 403 of each of the regenerative burners 2. Preferably, an inlet end of the combustion-supporting gas pipeline 402 can be connected to an air blower 602, and an outlet end of the flue gas pipeline 403 can be provided with an induced draft fan 601.

In the present embodiment, the operating principles of the alternate-switching regenerative apparatus are as follows.

Controlled under the controller, the first regenerative burner 21 is first used for combustion, and the second regenerative burner 22 and the third regenerative burner 23 are both used for smoke evacuation. At this moment, a first fuel gas valve 511 and a first combustion-supporting gas reversing valve 521 are activated, and a first flue gas reversing valve 531 is deactivated. Meanwhile, a second fuel gas valve 512, a second combustion-supporting gas reversing valve 522, a third fuel gas valve 513, and a third combustion-supporting gas reversing valve 523 are deactivated, while a second flue gas reversing valve 532 and a third flue gas reversing valve 533 are activated. Room temperature air (combustion-supporting gas), after flowing out of the air blower 602, enters the first regenerative burner 21 through the combustion-supporting gas pipeline 402 and the first combustion-supporting gas reversing valve 521, and is heated, while passing through the regenerator 203 provided in the first regenerative burner 21, to a temperature approximate to that of the furnace hearth 101 in an extremely brief period. The resulting heated high-temperature air, after entering the furnace hearth 101, will entrain flue gases around in the furnace hearth to form a thin oxygen-depleted high-temperature air stream having a content of oxygen significantly lower than 21%. At the same time, a fuel is injected into a center of the thin high-temperature air through the fuel gas pipeline 401 and the first fuel gas valve 511, and burns under an oxygen deficient state (2-20%). Flames generated thereby spew out of the burner nozzle. Meanwhile, all high-temperature flue gases generated during combustion in the furnace hearth 101 are promptly discharged by the second regenerative burner 22 and the third regenerative burner 23, through the flue gas pipeline 403. The high-temperature flue gases, while passing through the regenerative chambers 208 of the second regenerative burner 22 and the third regenerative burner 23, will store heat into the regenerators 203, and then be discharged under action of the induced draft fan 601, as low-temperature flow gases lower than 130° C., through the second flue gas reversing valve 532 and the third flue gas reversing valve 533.

After the first regenerative burner 21 performs combustion for a period of time, for example, 30 s, the controller switches the first regenerative burner 21 to smoke evacuation, and meanwhile switches the second regenerative burner 22 to combustion, while the third regenerative burner 23 will continue to be used for smoke evacuation.

After the second regenerative burner 22 performs combustion for a period of time, for example, 30 s, the controller switches the second regenerative burner 22 to smoke evacuation, and meanwhile switches the third regenerative burner 23 to combustion, while the first regenerative burner 21 will continue to be used for smoke evacuation. Successive switches can thus be achieved.

After the third regenerative burner 23 performs combustion for a period of time, for example, 30 s, the first regenerative burner 21 will, under control of the controller, be used for combustion again. Successive switches will be further performed, thereby achieving periodical switches of the three regenerative burners, so as to achieve combustion production. This can eliminate local high-temperature regions from the furnace hearth and render the temperature distribution homogeneous. The duration for one cycle can, for example, be 90 s.

As can be seen, during one cycle, each regenerative burner is used for smoke evacuation for 60 s, and combustion for 30 s. As compared with a regenerative combustion system provided with paired burners, the apparatus of the present invention has extended the operating time for smoke evacuation of a single regenerative burner. This enables thermal absorption of the regenerator to be more sufficient. As a result, the residual heat of high-temperature flue gases can be recovered to a maximum extent under the conditions of safe production, thus significantly lowering residual heat losses of the flue gases and reducing labor intensity in production.

Preferably, the first regenerative burner 21, the second regenerative burner 22, and the third regenerative burner 23 are the same as one another.

Table 1 shows experimental parameters as recorded during a manufacturing procedure according to one preferred embodiment of the alternate-switching regenerative combustion apparatus of the present invention used in melting aluminum.

TABLE 1
Ambient temperature: 33° C.
Combustion-supporting gas: air
Fuel: natural gas, Q_{d} = 35,171 kJ/Nm³

| | | | | | Temperature | | | | | |
|---|---|---|---|---|---|---|---|---|---|---|
| | | | Air flow | | of flue gases | Temperature | | | | |
| | | | rate | | entering the | of flue gases | Temperature | Pressure in | Temperature in | |
| | | Fuel gas | (Actually | Air flow | regenerative | being dis- | of pre-heat- | the furance | the furnance | Flue gas |
| | Recording | flow rate | measured | rate | chamber | charged | ed air | hearth | hearth | flow rate |
| Sequence | time | (Nm³/h) | m³/h) | (Nm³/h) | (° C.) | (° C.) | (° C.) | (Pa) | (° C.) | (Nm³/h) |
| 1 | 11:32:50 | 119.2 | 1315.56 | 1173.76 | 1175 | 111 | 1029 | 35 | 1098 | 1294.39 |
| 2 | 11:35:50 | 119.1 | 1314.46 | 1172.77 | 1150 | 116 | 1068 | 10 | 1198 | 1293.3 |
| 3 | 11:38:50 | 119.3 | 1316.66 | 1174.74 | 1188 | 116 | 1089 | 12 | 1238 | 1295.47 |
| 4 | 11:41:50 | 118.9 | 1312.25 | 1170.80 | 1198 | 118 | 1100 | 14 | 1270 | 1291.13 |
| 5 | 11:44:50 | 119 | 1313.35 | 1171.79 | 1198 | 122 | 1126 | 14 | 1279 | 1292.27 |
| 6 | 11:47:50 | 119.2 | 1315.56 | 1173.76 | 1201 | 125 | 1138 | −52 | 1278 | 1294.39 |

| | | | | | | | | |
|---|---|---|---|---|---|---|---|---|
| Average | 119.12 | 1314.64 | 1172.93 | 1185 | 118 | 1092 | 1227 | 1293.48 |

Table 1 shows that the alternate-switching regenerative combustion apparatus enabled a smoke evacuation temperature to be not higher than 130° C., and the temperature of the pre-heated combustion-supporting air to be only 100° C. lower than the temperature of the flue gases entering the regenerative chamber, which indicated 92% improvement of the temperature efficiency of the pre-heated combustion-supporting air. The furnace pressure fluctuation was controlled within a small range of ±60 Pa. Therefore, as compared with the prior art, the apparatus of the present invention is more energy efficient, more environmental friendly, and safer.

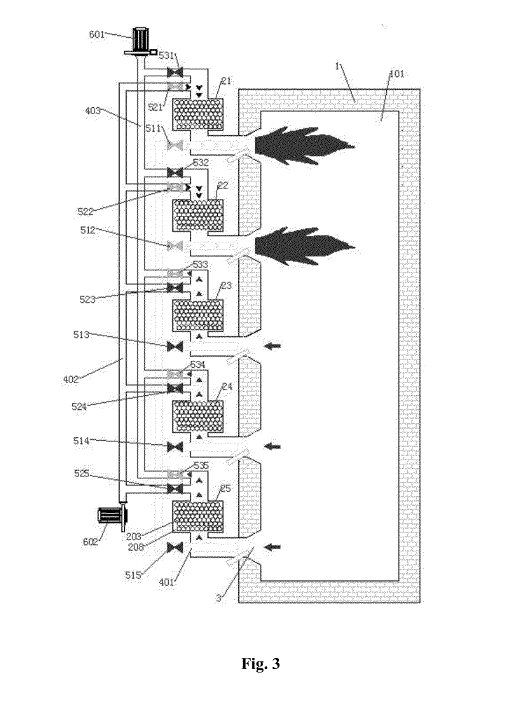

In another preferred embodiment as shown in FIG. 3, the alternate-switching regenerative combustion apparatus comprises five regenerative burners 2. Under such circumstances, controlled under the controller, one of the regenerative burners can be used for combustion, while the other four regenerative burners are used for smoke evacuation. Alternatively, under control of the controller, two of the regenerative burners can be used for combustion, while the other three regenerative burners are used for smoke evacuation. Preferably, controlled by the controller, a first regenerative burner 21 and a second regenerative burner 22 can be first used for combustion, while a third regenerative burner 23, a fourth regenerative burner 24, and a fifth regenerative burner 25 are used for smoke evacuation. In the latter case, the regenerative burners used for smoke evacuation is one more than the regenerative burners used for combustion. After the first regenerative burner 21 and the second regenerative burner 22 perform combustion simultaneously for 30 s, the controller can simultaneously switch the first regenerative burner 21 and the second regenerative burner 22 to smoke evacuation, and meanwhile switch any two of the other three regenerative burners for smoke evacuation to combustion. Alternatively, the first regenerative burner 21 and the second regenerative burner 22 can be switched to smoke evacuation at different times. For example, the controller can first switch the first regenerative burner 21 to smoke evacuation, without switching any one of the third regenerative burner 23, the fourth regenerative burner 24, and the fifth regenerative burner 25 to combustion at the same time (under such circumstances, only the second regenerative burner 22 is used for combustion, while the other four regenerative burners are used for smoke evacuation). After a while, the controller will switch the second regenerative burner 22 for combustion to smoke evacuation, and meanwhile switch any one of the third regenerative burner 23, the fourth regenerative burner 24, and the fifth regenerative burner 25 to combustion.

Preferably, after the first regenerative burner 21 and the second regenerative burner 22 perform combustion simultaneously for a period of time, for example, 30 s, the controller switches the first regenerative burner 21 to smoke evacuation, and meanwhile switches the third regenerative burner 23 to combustion. As such, the second regenerative burner 22 and the third regenerative burner 23 will be used for combustion, while the first regenerative burner 21, the fourth regenerative burner 24, and the fifth regenerative burner 25 will be used for smoke evacuation. After the second regenerative burner 22 and the third regenerative burner 23 continue to perform combustion for a period of time, for example, 30 s, the controller switches the second regenerative burner 22 to smoke evacuation, and meanwhile switches the fourth regenerative burner 24 to combustion. Thus, the third regenerative burner 23 and the fourth regenerative burner 24 will be used for combustion, while the first regenerative burner 21, the second regenerative burner 22, and the fifth regenerative burner 25 will be used for smoke evacuation, so on and so forth. The controller will successively and alternately switch the five regenerative burners to combustion or to smoke evacuation. When the first regenerative burner 21 is used for combustion again, the apparatus will complete a cycle.

As another preferred embodiment of the present invention, the regenerative burner 2 comprises at least one burner nozzle 3 communicating with the furnace hearth 101. The burner nozzles of the regenerative burners simultaneously switched each time have a same total power as the burner nozzles of the regenerative burners simultaneously switched at any other time. Preferably, each regenerative burner comprises one burner nozzle communicating with the furnace hearth, and the burner nozzles each have a same power. And each time one regenerative burner for combustion is switched to smoke evacuation, and meanwhile one regenerative burner for smoke evacuation is switched to combustion.

In another preferred embodiment, the regenerators 203 are all located above the burner nozzles 3. When the first regenerative burner 21, for example, is used for smoke evacuation, high-temperature flue gases and dusts pass through the regenerator 203 from bottom to top. Dusts can hardly accumulate on the regenerator 203 in large amounts due to gravity thereof. When the controller switches the first regenerative burner 21 to combustion, combustion-supporting gases pass through the regenerator 203 from top to bottom, thereby sweeping off the dusts rather easily. As compared with a regenerative combustion apparatus having an under-mounted regenerator, in the apparatus of the present invention, the speed at which the combustion-supporting gases pass through the regenerator 203 is larger than the speed at which flue gases pass through the regenerator. Therefore, the apparatus of the present invention has significantly improved self-cleaning capability. As a result, the regenerator 203 does not easily get dusty or hardened, thereby remarkably extending cleaning cycle and service life of the regenerator 203, and cutting down workload and costs for maintenance of the regenerator.

In another preferred embodiment, the apparatus of the present invention is used in an aluminum melting furnace. The cleaning cycle of the regenerator 203 can reach 6-month long. However, when an under-mounted regenerator is used on the same conditions, the cleaning cycle and the service life of the regenerator 203 can be at most three months.

Preferably, the regenerative chambers 208 are all placed on top of the furnace body 1, thereby not only saving space, but also improving efficiency of smoke evacuation.

Preferably, the regenerator 203 is a spherical one made of corundum.

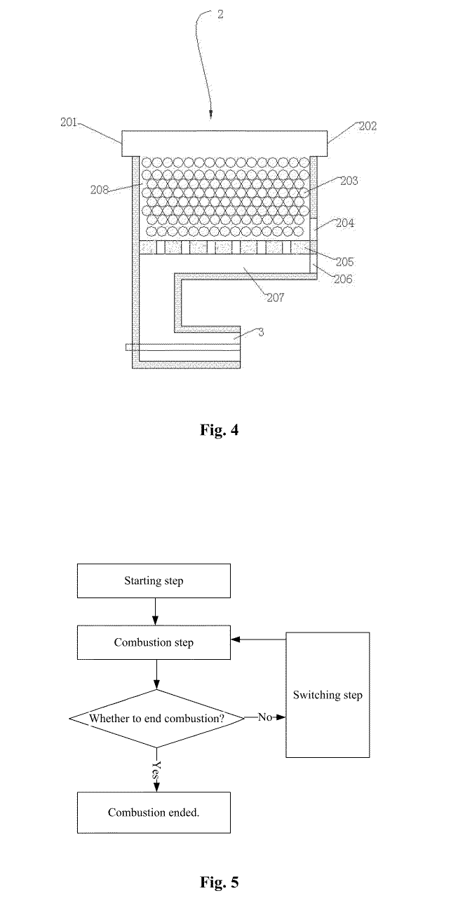

In another preferred embodiment as shown in FIG. 4, an inner cavity of the regenerative chamber 208 is divided into two portions by grate brick 205 provided with through-holes, including an upper portion and a lower portion. The grate brick 205 is the same as the regenerative chamber 208 in shape, and can be, for example, a cylinder or a cube. However, the height of the grate brick 205 is smaller than that of the regenerative chamber 208 in a vertical direction. The regenerator 203 is located above the grate brick 205. A top of the regenerative chamber 208 is provided with the air inlet 201 communicating with the combustion-supporting gas pipeline 402, and the smoke vent 202 communicating with the flue gas pipeline 403. A dust chamber 207 is provided below the grate brick 205. A goalmouth 204 for placing or taking away the regenerator is provided in the upper portion of the regenerative chamber 208 on a side wall thereof adjacent to the grate brick 205. And a cleaning door 206 is provided in the lower portion of the regenerative chamber 208 on a side wall thereof adjacent to the bottom for cleaning dusts.

Preferably, the upper portion is provided with a high-temperature section adjacent to the grate brick 205, and a low-temperature section adjacent to the smoke vent. The high-temperature section refers to a region in the regenerative chamber 208 having a relatively high regenerative temperature, and the low-temperature section refers to a region in the regenerative chamber 208 having a relatively low regenerative temperature. Division of the high-temperature section and the low-temperature section can be completed as per production requirements.

Preferably, the regenerator 203 comprises a plurality of large-diameter regenerative balls provided in the high-temperature section, and a plurality of small-diameter regenerative balls provided in the low-temperature section. The large diameter and small diameter herein are relative to each other. That is, the diameter of the large-diameter regenerative balls placed in the high-temperature section is larger than the diameter of the small-diameter balls placed in the low-temperature section. The actual sizes of the regenerative balls should be set forth as per actual production requirements. Although regenerative balls are used in the present embodiment, other shapes originated from the design conception of the present invention are covered in the scope of the present invention also. High-temperature flue gases generated during combustion first enter the high-temperature section under suction of the induced draft fan 601. Since the large-diameter regenerative balls are placed in the high-temperature section, and relatively large intervals are formed between and among the large-diameter regenerative balls, the high-temperature flue gases have relatively large flow areas. Thus, the flue gases will meet relatively small resistance in the high-temperature section, and transfer heat partially to the large-diameter regenerative balls. Otherwise, in case regenerative balls of unified specification are used in the regenerative chamber 208, the flue gases would meet rather large resistance in the high-temperature section. Under such circumstances, it would be necessary for the induced draft fan 601 to gain power and increase suction intensity performed on the flue gases. Flue gases that have passed through the high-temperature section will carry with them a reduced amount of heat at a decreased temperature. The high-temperature flue gases then enter the low-temperature section. As the small-diameter regenerative balls have large specific surface areas, flue gases of relatively low temperature can get into adequate contact with the small-diameter regenerative balls, thereby facilitating adequate heat exchange therebetween, and thermal storage of the regenerative balls. During a next cycle, heat stored in the regenerative balls is transferred to combustion-supporting gases passing therethrough, so as to improve the temperature of the combustion-supporting gases, and drop down using amounts of fuels in combustion production. As can be seen, production operating costs can be lowered in both heat storage and heating of the combustion-supporting gases, which is favorable for energy conservation and environment protection.

The method for controlling the switching regenerative combustion apparatus according to the present invention comprises a starting step, a combustion step, a switching step, and a circulation step as indicated in FIG. 5. In the following, each of the steps of the method for controlling the switching regenerative combustion apparatus of the present invention will be explained in detail.

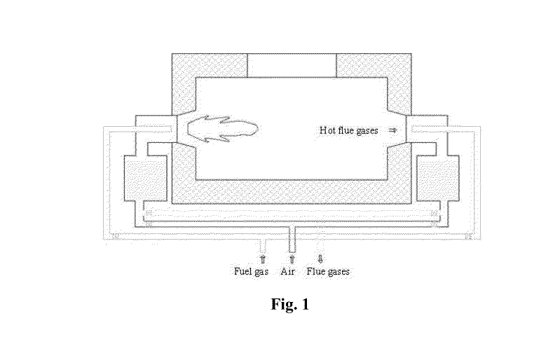

The starting step comprises starting m regenerative burners for combustion, and meanwhile starting n regenerative burners for smoke evacuation, wherein n and m are both natural numbers, and n>m, and n+m≧3. That is, the regenerative burners for smoke evacuation is at least one more than the regenerative burners for combustion. In one embodiment, as shown in FIG. 1, m=1, and n=2. The controller starts the first regenerative burner 21 for combustion, and meanwhile starts the second regenerative burner 22 and the third regenerative burner 23 for smoke evacuation.

In the combustion step, under the control of the controller, the first regenerative burner for combustion performs combustion production, and meanwhile, the second regenerative burner 22 and the third regenerative burner 23 promptly discharge all flue gases out of the furnace hearth. At this moment, the first fuel gas valve 511 and the first combustion-supporting gas reversing valve 521 are activated, and the first flue gas reversing valve 531 is deactivated. Meanwhile, the second fuel gas valve 512, the second combustion-supporting gas reversing valve 522, the third fuel gas valve 513, and the third combustion-supporting gas reversing valve 523 are deactivated, while the second flue gas reversing valve 532 and the third flue gas reversing valve 533 are activated. Room temperature air (combustion-supporting gas), after flowing out of the air blower 602, enters the first regenerative burner 21 through the combustion-supporting gas pipeline 402 and the first combustion-supporting gas reversing valve 521, and is heated, while passing through the regenerator 203 provided in the first regenerative burner 21, to a temperature approximate to the temperature of the furnace hearth 101 in an extremely brief period. The resulting heated high-temperature air, after entering the furnace hearth 101, will entrain flue gases around in the furnace hearth to form a thin oxygen-depleted high-temperature air stream having a content of oxygen significantly lower than 21%. At the same time, a fuel is injected into a center of the thin high-temperature air through the fuel gas pipeline 401 and the first fuel gas valve 511, and burns under an oxygen deficient state (2-20%). Flames generated thereby spew out of the burner nozzle. Meanwhile, all high-temperature flue gases generated during combustion in the furnace hearth 101 are promptly discharged by the second regenerative burner 22 and the third regenerative burner 23, through the flue gas pipeline 403. The high-temperature flue gases, while passing through the regenerative chambers 208 of the second regenerative burner 22 and the third regenerative burner 23, will store heat into the regenerators 203, and then be discharged under action of the induced draft fan, as low-temperature flow gases lower than 130° C., through the second flue gas reversing valve 532 and the third flue gas reversing valve 533.

The switching step comprises switching at least one of the regenerative burners for combustion to smoke evacuation, and meanwhile switching at least one of the regenerative burners for smoke evacuation to combustion, so as to enable the regenerative burners for smoke evacuation to be more than the regenerative burners for combustion. In the switching step of the present embodiment, the first regenerative burner 21 for combustion is switched to smoke evacuation, and meanwhile, the second regenerative burner 22 for smoke evacuation is switched to combustion. In the combustion apparatus after switching then, the first regenerative burner 21 and the third regenerative burner 23 will be used for smoke evacuation, while the second regenerative burner 22 will be used for combustion.

The circulation step comprises returning to execute the combustion step and the combustion step, until combustion finishes. In the present embodiment, the second regenerative burner 22 for combustion is switched to smoke evacuation, and meanwhile, the third regenerative burner 23 for smoke evacuation is switched to combustion. As a result, in the combustion apparatus after a second switching, the first regenerative burner 21 and the second regenerative burner 22 will be used for smoke evacuation, while the third regenerative burner 23 will be used for combustion. A cycle of the method of the present invention will be completed upon completion of combustion in the third regenerative burner. More cycles will start in circulation until the end of combustion.

In the switching step of the present embodiment, one of the regenerative burners for combustion is switched to smoke evacuation, and meanwhile, one of the regenerative burners for smoke evacuation is switched to combustion. This can result in better effects of smoke evacuation and stabler furnace pressure.

In the switching step of the present embodiment, the first regenerative burner 21, the second regenerative burner 22, and the third regenerative burner 23 are successively switched for combustion and smoke evacuation alternately, so as to ensure that the regenerative burners in the state of smoke evacuation is one more than the regenerative burners in the state of combustion. Thus, the time for smoke evacuation of a single regenerative burner can be prolonged, thereby rendering thermal absorption of the regenerator more adequate. As a result, an overall residual heat of high-temperature flue gases can be recovered to a maximum extent under the conditions of safe production, thus improving manufacture and surrounding environments, significantly lowering losses of residual heat, and reducing labor intensity in production. In addition, the method of the present invention further reduces differential pressure in the furnace hearth and ensures stable operation of combustion production.

In the present embodiment, the switching step is performed periodically among the three regenerative burners, after which, the switching step is re-executed with the first regenerative burner 21 for combustion. Thus, combustion production can be performed in circulation until the end of the production.

In the present embodiment, the apparatus comprises three regenerative burners, and the duration for each cycle is 60 s. In one cycle, the operating time of each regenerative burner for combustion is preferably 20 s, and the operating time of each regenerative burner for smoke evacuation is 40 s. The time interval at which the controller switches between two regenerative burners equals the operating time of the regenerative burner for combustion, i.e., 20 s.

FIG. 3 shows another preferred embodiment of the present invention. In the embodiment as shown in FIG. 3, the regenerative combustion apparatus comprises five regenerative burners 2. The controller starts the first regenerative burner 21 and the second regenerative burner 22 first for combustion, and meanwhile starts the third regenerative burner 23, the fourth regenerative burner 24, and the fifth regenerative burner 25 for smoke evacuation. Thus, the regenerative burners for smoke evacuation are one more than the regenerative burners for combustion. That is, m=2, and n=3.

In the combustion step, the first regenerative burner 21 and the second regenerative burner 22 perform combustion, and meanwhile the third regenerative burner 23, the fourth regenerative burner 24, and the fifth regenerative burner 25 are used for smoke evacuation.

In the switching step, the controller can simultaneously switch the first regenerative burner 21 and the second regenerative burner 22 to smoke evacuation, and meanwhile switch any two of the other three regenerative burners to combustion. Alternatively, the controller can switch the first regenerative burner 21 and the second regenerative burner 22 to smoke evacuation at different times. For example, the controller can first switch the first regenerative burner 21 to smoke evacuation, without switching any one of the third regenerative burner 23, the fourth regenerative burner 24, and the fifth regenerative burner 25 to combustion at the same time, such that only the second regenerative burner 22 is used for combustion, while the other four regenerative burners are all used for smoke evacuation. After a while, the controller switches the second regenerative burner 22 for combustion to smoke evacuation, and meanwhile switch any one of the third regenerative burner 23, the fourth regenerative burner 24, and the fifth regenerative burner 25 to combustion.

Preferably, after the first regenerative burner 21 and the second regenerative burner 22 perform combustion simultaneously for a while, for example, 30 s, the controller simultaneously switches the first regenerative burner 21 and the second regenerative burner 22 to smoke evacuation, and meanwhile simultaneously switches the third regenerative burner 23 and the fourth regenerative burner 24 to combustion. Thus, the third regenerative burner 23 and the fourth regenerative burner 24 perform combustion, while the first regenerative burner 21, the second regenerative burner 22, and the fifth regenerative burner 25 perform smoke evacuation, and discharge all flue gases out of the furnace hearth promptly. After the third regenerative burner 23 and the fourth regenerative burner 24 perform combustion for a while, for example, 30 s, the controller successively switches the third regenerative burner 23 and the fourth regenerative burner 24 to smoke evacuation, and meanwhile successively switches the first regenerative burner 21 and the fifth regenerative burner 25 to combustion. Thus, the first regenerative burner 21 and the fifth regenerative burner 25 will perform combustion, while the second regenerative burner 22, the third regenerative burner 23, and the fourth regenerative burner 24 will perform smoke evacuation, so on and so forth. In the switching step of the present embodiment, two of the regenerative burners for combustion are switched to smoke evacuation, and meanwhile two of the regenerative burners for smoke evacuation are switched to combustion, thereby achieving better smoke evacuation effects and stable furnace pressure. In the present embodiment, the switching step is performed periodically among the five regenerative burners, after which, the combustion step is re-executed with the first regenerative burner 21 and the second regenerative burner 22 that are for combustion. Thus, combustion production can be performed in circulation until the end of the production.

Compared with the prior art, the switching regenerative combustion apparatus and the method of the present invention have the following prominent technical effects.

(1) Smooth smoke evacuation and stable furnace pressure. Flue gases generated during combustion can be all discharged by the regenerative burners in a prompt manner, thus ensuring safety operation of the apparatus.

(2) Small temperature differences and superior heating quality. Homogeneous temperature distribution with a temperature difference of ±5° C., and a relatively low oxygen environment in the combustion furnace are extremely favorable for heating of workpiece. Not only heating speed and quality can be improved, but oxidization ratio of the workpiece can be also lowered, thereby significantly improving yield of the furnace.

(3) Remarkable energy-saving effects. The overall recovery rate of residual heat of the flue gases is improved to higher than 80%, which saves at least 20-25% of energy as compared with an existing regenerative combustion apparatus having paired burners. This indicates enormous energy-saving potential.

(4) Small amounts of pollutant emissions. Adequate combustion largely reduces contents of CO, CO₂, and other greenhouse gases in the flue gases. Combustion environment of high temperature and low oxygen, and blending effects of flue gas reflux tremendously restrains generation of NOₓ. In addition, the high-temperature environment inhibits generation of dioxin. Rapid cooling of exhaust gases effectively prevents re-synthesis of dioxin. Thus, emissions of dioxin can be remarkably decreased. Moreover, gradual diffusive combustion of flames over the entire furnace hearth produces slight noises only. Therefore, the apparatus or method of the present invention belongs to environment coordination regenerative combustion technology.

It should be noted that the above embodiments are only used to explain, rather than to limit the present invention in any manner. Although the present invention has been discussed with reference to preferable embodiments, it should be understood that the terms and expressions adopted are for describing and explaining instead of limiting the present invention. The present invention can be modified within the scope of the claims, or can be amended without departing from the scope or spirits of the present invention. Although the present invention is described with specific methods, materials, and embodiments, the scope of the present invention herein disclosed should not be limited by the particularly disclosed embodiments as described above, but can be extended to other methods and uses having the same functions.

### LIST OF REFERENCE NUMBERS

1: furnace body;
101: furnace hearth;
2, 21, 22, 23, 24, and 25: regenerative burners;
201: air inlet;
202: smoke vent;
203: regenerator;
204: goalmouth;
205: grate brick;
206: cleaning door;
207: dust chamber;
208: regenerative chamber;
3: burner nozzle;
401: fuel gas pipeline;
402: combustion-supporting gas pipeline;
403: flue gas pipeline;
51: fuel gas valve;
511: first fuel gas valve;
512: second fuel gas valve;
513: third fuel gas valve;
52: combustion-supporting gas reversing valve;
521: first combustion-supporting gas reversing valve;
522: second combustion-supporting gas reversing valve;
523: third combustion-supporting gas reversing valve;
53: flue gas reversing valve;
531: first flue gas reversing valve;
532: second flue gas reversing valve;
533: third flue gas reversing valve;
601: induced draft fan; and
602: air blower

1. An alternate-switching regenerative combustion apparatus, comprising at least three regenerative burners communicating with a furnace hearth, and a controller used for controlling the regenerative burners, wherein the controller switches the regenerative burners to combustion and smoke evacuation alternately, so as to enable, at any moments, the regenerative burners used for smoke evacuation to be more than the regenerative burners used for combustion.

2. The apparatus according to claim 1, wherein flue gases in the furnace hearth are all discharged via the regenerative burners for smoke evacuation.

3. The apparatus according to claim 1, wherein the controller switches at least one of the regenerative burners for combustion to smoke evacuation, and meanwhile switches at least one of the regenerative burners for smoke evacuation to combustion.

4. The apparatus according to claim 1, wherein the controller switches one of the regenerative burners for combustion to smoke evacuation, and meanwhile switches one of the regenerative burners for smoke evacuation to combustion.

5. The apparatus according to claim 1, wherein the controller successively switches the regenerative burners for combustion to smoke evacuation, and successively switches the regenerative burners for smoke evacuation to combustion.

6. The apparatus according to claim 1, wherein the controller periodically switches the regenerative burners for combustion to smoke evacuation, and periodically switches the regenerative burners for smoke evacuation to combustion.

7. (canceled)

8. The apparatus according to claim 1, wherein the regenerative burner comprises at least one burner nozzle communicating with the furnace hearth, and the burner nozzles of the regenerative burners simultaneously switched each time have a same total power as the burner nozzles of the regenerative burners simultaneously switched at any other time.

9. The apparatus according to claim 1, wherein each of the regenerative burners includes a regenerative chamber, which has one end communicating with the furnace hearth via the burner nozzle, and the other end provided with an air inlet and a smoke vent, wherein the air inlet communicates with a combustion-supporting gas pipeline through which combustion-supporting gases are supplied, and the smoke vent communicates with a flue gas pipeline used for smoke evacuation.

10. The apparatus according to claim 9, wherein the regenerative chamber is provided with a regenerator in shape of a sheet, strip, honeycomb, or sphere, preferably a sphere, and the regenerator is made of clay, mullite, high aluminum, corundum, or silicon carbide, preferably corundum.

11-12. (canceled)

13. The apparatus according to claim 9, wherein the regenerative chamber is divided, by grate brick having through-holes, into two portions including an upper portion and a lower portion, and
wherein the regenerator is located above the grate brick, and a dust chamber is provided below the grate brick.

14. The apparatus according to claim 13, wherein above the grate brick, it is provided with a high-temperature section adjacent to the grate brick and a low-temperature section adjacent to the smoke vent.

15. (canceled)

16. The apparatus according to claim 1, wherein the regenerative burners are the same with one another.

17. A method for controlling a regenerative combustion apparatus, comprising:
a starting step: starting m regenerative burners for combustion, and meanwhile starting n regenerative burners for smoke evacuation, wherein n and m are both natural numbers, and n>m, and n+m≧3;
a combustion step: enabling the regenerative burners for combustion to perform combustion, and the regenerative burners for smoke evacuation to discharge flue gases out of a furnace hearth;
a switching step: switching at least one of the regenerative burners for combustion to smoke evacuation, and switching at least one of the regenerative burners for smoke evacuation to combustion, so as to enable the regenerative burners for smoke evacuation to be more than the regenerative burners for combustion; and
a circulation step: returning to execute the combustion step until combustion finishes.

18. The method according to claim 17, wherein flue gases in the furnace hearth are all discharged via the regenerative burners for smoke evacuation.

19. The method according to claim 17, wherein in the switching step, at least one of the regenerative burners for combustion is switched to smoke evacuation, and meanwhile at least one of the regenerative burners for smoke evacuation is switched to combustion.

20. The method according to claim 17, wherein in the switching step, one of the regenerative burners for combustion is switched to smoke evacuation, and meanwhile one of the regenerative burners for smoke evacuation is switched to combustion.

21. The method according to claim 17, wherein in the switching step, the regenerative burners for combustion are successively switched to smoke evacuation, and the regenerative burners for smoke evacuation are successively switched to combustion.

22. The method according to claim 17, wherein in the switching step, the regenerative burners for combustion are periodically switched to smoke evacuation, and the regenerative burners for smoke evacuation are periodically switched to combustion.

23. The method according to claim 22, wherein during one cycle, the combustion time of each of the regenerative burners for combustion is T×m/(m+n), wherein T represents duration of one cycle.

24. The method according to claim 17, wherein in the starting step, the m regenerative burners are simultaneously started for combustion, wherein m≧2.
